(19) United States
(12) Patent Application Publication
(10) Pub. No.: US 2026/0172844 A1
(43) Pub. Date: Jun. 18, 2026

(54) COEXISTENCE STRATEGIES FOR DIFFERENT WIRELESS COMMUNICATIONS NETWORKS THAT USE SHARED RADIO FREQUENCY SPECTRUM

(71) Applicant: QUALCOMM Incorporated, San Diego, CA (US)

(72) Inventors: Abhishek Pramod PATIL, San Diego, CA (US); Aleksandar DAMNJANOVIC, Del Mar, CA (US); George CHERIAN, San Diego, CA (US)

(21) Appl. No.: 18/983,075

(22) Filed: Dec. 16, 2024

(51) Int. Cl. H04W 16/14; H04W 48/16

(52) U.S. Cl. CPC H04W 16/14; H04W 48/16

(57) ABSTRACT

This disclosure provides methods, components, devices and systems for coexistence strategies for different wireless communications networks that use shared radio frequency spectrum. Some aspects more specifically relate to coexistence strategies for different wireless communications networks associated with different radio access technologies (RATs) that may use a same shared frequency band. A first wireless device of a first RAT, such as a cellular RAT, may transmit a signal that a second wireless device associated with a second RAT, such as a Wi-Fi RAT, may detect. The signal may be used to provide an indication that the second wireless device is to adjust communications using the shared frequency band. The signal may be a message according to an uplink relaying protocol, such as an enhanced broadcast services (EBCS) uplink frame that indicates a presence of the first wireless device on the shared frequency band.

### TECHNICAL FIELD

This disclosure relates generally to wireless communication and, more specifically, to coexistence strategies for different wireless communications networks associated with different radio access technologies that use shared radio frequency spectrum.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication performed by a wireless access point (AP). The method may include monitoring at least a first communications channel of a shared radio frequency spectrum band for one or more enhanced broadcast service (EBCS) uplink frames, receiving an EBCS uplink frame that indicates a presence of a network entity associated with a second wireless network associated with a second radio access technology (RAT) different than a first RAT associated with a first wireless network associated with the AP, where the network entity of the second wireless network, or the second wireless network, has priority over the AP for communication using the shared radio frequency spectrum band, and adapting communications of the AP via the shared radio frequency spectrum band in accordance with the network entity of the second wireless network, or the second network, having priority over the AP for communication using the shared radio frequency spectrum band.

Another innovative aspect of the subject matter described in this disclosure can be implemented in a wireless AP for wireless communications. The wireless AP may include a processing system that includes processor circuitry and memory circuitry that stores code. The processing system may be configured to cause the wireless AP to monitor at least a first communications channel of a shared radio frequency spectrum band for one or more EBCS uplink frames, receive an EBCS uplink frame that indicates a presence of a network entity associated with a second wireless network associated with a second RAT different than a first RAT associated with a first wireless network associated with the AP, where the network entity of the second wireless network, or the second wireless network, has priority over the AP for communication using the shared radio frequency spectrum band, and adapt communications of the AP via the shared radio frequency spectrum band in accordance with the network entity of the second wireless network, or the second network, having priority over the AP for communication using the shared radio frequency spectrum band.

Another innovative aspect of the subject matter described in this disclosure can be implemented in a wireless AP for wireless communications. The wireless AP may include means for monitoring at least a first communications channel of a shared radio frequency spectrum band for one or more EBCS uplink frames, means for receiving an EBCS uplink frame that indicates a presence of a network entity associated with a second wireless network associated with a second RAT different than a first RAT associated with a first wireless network associated with the AP, where the network entity of the second wireless network, or the second wireless network, has priority over the AP for communication using the shared radio frequency spectrum band, and means for adapting communications of the AP via the shared radio frequency spectrum band in accordance with the network entity of the second wireless network, or the second network, having priority over the AP for communication using the shared radio frequency spectrum band.

Another innovative aspect of the subject matter described in this disclosure can be implemented in a non-transitory computer-readable medium storing code for wireless communication. The code may include instructions executable by one or more processors to monitor at least a first communications channel of a shared radio frequency spectrum band for one or more EBCS uplink frames, receive an EBCS uplink frame that indicates a presence of a network entity associated with a second wireless network associated with a second RAT different than a first RAT associated with a first wireless network associated with the AP, where the network entity of the second wireless network, or the second wireless network, has priority over the AP for communication using the shared radio frequency spectrum band, and adapt communications of the AP via the shared radio frequency spectrum band in accordance with the network entity of the second wireless network, or the second network, having priority over the AP for communication using the shared radio frequency spectrum band.

In some examples of the method, wireless APs, and non-transitory computer-readable medium described herein, the EBCS uplink frame may be transmitted by a transmitter associated with the second wireless network that may be acting as an EBCS station (STA) of the first wireless network.

In some examples of the method, APs, and non-transitory computer-readable medium described herein, the second wireless network may be a cellular network or a third generation partnership project (3GPP)-based network, and the first wireless network may be a wireless local area network (WLAN) that operates in accordance with an Institute of Electrical and Electronics Engineers (IEEE) 802.11 protocol and the transmitter associated with the second wireless network may be the network entity or a user equipment (UE) associated with the second wireless network.

In some examples of the method, APs, and non-transitory computer-readable medium described herein, the shared radio frequency spectrum band may be an upper 6 GHz band that may be shared by one or more cellular networks and one or more wireless local area networks. Some examples of the method, APs, and non-transitory computer-readable medium described herein may further include operations, features, means, or instructions for monitoring at least the first communications channel of the shared radio frequency spectrum band may be in accordance with a periodicity for transmission of the EBCS uplink frames that indicate the presence of the network entity of the second wireless network.

Some examples of the method, APs, and non-transitory computer-readable medium described herein may further include operations, features, means, or instructions for determining, in accordance with one or more address fields of the EBCS uplink frame, that the EBCS uplink frame may be associated with an indication of the presence of the network entity of the second wireless network.

Some examples of the method, APs, and non-transitory computer-readable medium described herein may further include operations, features, means, or instructions for decoding a universal resource indicator (URI) from the EBCS uplink frame and obtaining an indication from a server associated with the URI that the communications of the AP via the shared radio frequency spectrum band may be to be adjusted, and one or more corresponding parameters associated with the communications of the AP via the shared radio frequency spectrum band.

Some examples of the method, APs, and non-transitory computer-readable medium described herein may further include operations, features, means, or instructions for validating the EBCS uplink frame in accordance with a frame transmit time and a frame count value indicated by the EBCS uplink frame, and where the adapting may be performed in accordance with the validated EBCS uplink frame.

In some examples of the method, APs, and non-transitory computer-readable medium described herein, the EBCS uplink frame may be validated in accordance with an operator certificate indicated by the EBCS uplink frame. Some examples of the method, APs, and non-transitory computer-readable medium described herein may further include operations, features, means, or instructions for validating, in accordance with a predefined field value of a first field of the EBCS uplink frame, that the EBCS uplink frame may be authentic and parsing, responsive to validation of the EBCS uplink frame, a payload of the EBCS uplink frame, where one or more parameters for adapting communications of the AP via the shared radio frequency spectrum band may be indicated in the payload.

Some examples of the method, APs, and non-transitory computer-readable medium described herein may further include operations, features, means, or instructions for determining that at least one of one or more address fields of the EBCS uplink frame, or the value carried in a URI field of the EBCS uplink frame, correspond to a predefined address field value, and where adapting the communications of the AP may be performed in accordance with one or more predetermined actions associated with the predefined address field value without forwarding any portion of the EBCS uplink frame to a different entity.

In some examples of the method, APs, and non-transitory computer-readable medium described herein, the first communications channel may be a preferred scanning channel of the AP within a basic service set bandwidth of the AP. Some examples of the method, APs, and non-transitory computer-readable medium described herein may further include operations, features, means, or instructions for monitoring one or more other preferred scanning channels that may be outside of the basic service set bandwidth of the AP for the EBCS uplink frame. In some examples of the method, APs, and non-transitory computer-readable medium described herein, the first communications channel may be a common channel that may be within or outside of a basic service set bandwidth of the AP.

In some examples of the method, APs, and non-transitory computer-readable medium described herein, the first communications channel may be monitored in association with a procedure to identify an available frequency band for operation of the AP within the first wireless network and the first communications channel may be monitored for a time period in accordance with a periodicity of transmissions of EBCS uplink frames.

Some examples of the method, APs, and non-transitory computer-readable medium described herein may further include operations, features, means, or instructions for communicating, prior to receiving the EBCS uplink frame, with one or more stations (STAs) that may be associated with the AP using at least the first communications channel, and where the monitoring the first communications channel may be performed periodically in accordance with a periodicity of transmissions of EBCS uplink frames. In some examples of the method, APs, and non-transitory computer-readable medium described herein, the first communications channel may be outside of a primary channel of the AP, and where the method further includes and transmitting an indication to one or more associated stations (STAs) that the AP may be unavailable for communications during a monitoring instance of the first communications channel. In some examples of the method, APs, and non-transitory computer-readable medium described herein, the first communications channel may be outside of a primary channel of the AP, and where the first communications channel may be monitored using an auxiliary radio of the AP that may be different than a primary radio used for communication with one or more associated stations (STAs) of the AP within the basic service set bandwidth.

Some examples of the method, APs, and non-transitory computer-readable medium described herein may further include operations, features, means, or instructions for communicating with one or more associated stations (STAs) via the shared radio frequency spectrum band, requesting one or more associated STAs to monitor for EBCS uplink frames, and monitoring the first communications channel based on receiving an indication of presence of at least one EBCS uplink frame from the one or more associated STAs.

In some examples of the method, APs, and non-transitory computer-readable medium described herein, a field within a PPDU containing the EBCS uplink frame may be received in a non-high-throughput (non-HT) duplicate physical layer protocol data unit (PPDU). In some examples of the method, APs, and non-transitory computer-readable medium described herein, a field within a physical layer protocol data unit (PPDU) containing the EBCS uplink frame indicates an operational bandwidth of the network entity.

Another innovative aspect of the subject matter described in this disclosure can be implemented in a method for wireless communications by a network entity. The method may include transmitting, to one or more APs associated with a first wireless network associated with a first RAT different than a second RAT associated with a second wireless network associated with the network entity, on a first communications channel of a shared radio frequency spectrum band, one or more EBCS uplink frames that indicate a presence of communications of the network entity on at least a portion of the shared radio frequency spectrum band, where the network entity, or the second wireless network, has priority over the one or more APs for communication using the shared radio frequency spectrum band and communicating with at least a first UE via at least the portion of the shared radio frequency spectrum band.

Another innovative aspect of the subject matter described in this disclosure can be implemented in a network entity for wireless communications. The network entity may include a processing system that includes processor circuitry and memory circuitry that stores code. The processing system may be configured to cause the network entity to transmit, to one or more APs associated with a first wireless network associated with a first RAT different than a second RAT associated with a second wireless network associated with the network entity, on a first communications channel of a shared radio frequency spectrum band, one or more EBCS uplink frames that indicate a presence of communications of the network entity on at least a portion of the shared radio frequency spectrum band, where the network entity, or the second wireless network, has priority over the one or more APs for communication using the shared radio frequency spectrum band and communicate with at least a first UE via at least the portion of the shared radio frequency spectrum band.

Another innovative aspect of the subject matter described in this disclosure can be implemented in a network entity for wireless communications. The network entity may include means for transmitting, to one or more APs associated with a first wireless network associated with a first RAT different than a second RAT associated with a second wireless network associated with the network entity, on a first communications channel of a shared radio frequency spectrum band, one or more EBCS uplink frames that indicate a presence of communications of the network entity on at least a portion of the shared radio frequency spectrum band, where the network entity, or the second wireless network, has priority over the one or more APs for communication using the shared radio frequency spectrum band and means for communicating with at least a first UE via at least the portion of the shared radio frequency spectrum band.

Another innovative aspect of the subject matter described in this disclosure can be implemented in a non-transitory computer-readable medium storing code for wireless communication. The code may include instructions executable by one or more processors to transmit, to one or more APs associated with a first wireless network associated with a first RAT different than a second RAT associated with a second wireless network associated with the network entity, on a first communications channel of a shared radio frequency spectrum band, one or more EBCS uplink frames that indicate a presence of communications of the network entity on at least a portion of the shared radio frequency spectrum band, where the network entity, or the second wireless network, has priority over the one or more APs for communication using the shared radio frequency spectrum band and communicate with at least a first UE via at least the portion of the shared radio frequency spectrum band.

In some examples of the method, network entities, and non-transitory computer-readable medium described herein, the network entity acts as an EBCS STA of the first wireless network when transmitting the one or more EBCS frames. In some examples of the method, network entities, and non-transitory computer-readable medium described herein, the second wireless network may be a cellular network or a third generation partnership project (3GPP)-based network, and the first wireless network may be a WLAN that operates in accordance with an Institute of Electrical and Electronics Engineers (IEEE) 802.11 protocol.

Some examples of the method, network entities, and non-transitory computer-readable medium described herein may further include operations, features, means, or instructions for transmitting the one or more EBCS uplink frames may be in accordance with a periodicity for transmission of EBCS uplink frames that indicate the presence of the network entity in the shared radio frequency spectrum band. Some examples of the method, network entities, and non-transitory computer-readable medium described herein may further include operations, features, means, or instructions for configuring the first UE to transmit one or more EBCS uplink frames in accordance with a presence of one or more defined conditions at the UE.

In some examples of the method, network entities, and non-transitory computer-readable medium described herein, the one or more defined conditions include a packet error rate for uplink communications of the first UE exceeding a threshold value due to interference associated with communications of the first wireless network.

In some examples of the method, network entities, and non-transitory computer-readable medium described herein, the first UE may be configured with one or more security credentials for authentication of the one or more EBCS uplink frames.

In some examples of the method, network entities, and non-transitory computer-readable medium described herein, the first communications channel may be a preferred scanning channel within a basic service set bandwidth of the one or more APs. In some examples of the method, network entities, and non-transitory computer-readable medium described herein, the first communications channel may be a common channel that may be within or outside of a basic service set bandwidth of the one or more APs.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example of an enhanced broadcast service (EBCS) frame that supports coexistence strategies for different wireless communications networks that use shared radio frequency spectrum.

FIG. 4 shows an example of a signaling diagram that supports coexistence strategies for different wireless communications networks that use shared radio frequency spectrum.

FIG. 5 shows an example of a channel bandwidth of an AP and a network entity that supports coexistence strategies for different wireless communications networks that use shared radio frequency spectrum.

FIGS. 6A and 6B show examples of preferred scanning channels in 100 MHz channel bandwidths of a network entity that supports coexistence strategies for different wireless communications networks that use shared radio frequency spectrum.

FIG. 7 shows an example of channel bandwidth of an AP and a network entity that supports coexistence strategies for different wireless communications networks that use shared radio frequency spectrum.

FIG. 8 shows a block diagram of an example wireless communication device that supports coexistence strategies for different wireless communications networks that use shared radio frequency spectrum.

FIG. 9 shows a block diagram of an example wireless communication device that supports coexistence strategies for different wireless communications networks that use shared radio frequency spectrum.

FIG. 10 shows a flowchart illustrating an example process performable by or at a wireless access point (AP) that supports coexistence strategies for different wireless communications networks that use shared radio frequency spectrum.

FIG. 11 shows a flowchart illustrating an example process performable by or at a network entity that supports coexistence strategies for different wireless communications networks that use shared radio frequency spectrum.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, wireless devices in the network may operate in frequency bands that are shared with other operators. Further, in some deployments, different wireless communication networks that operate in a shared radio frequency spectrum band may use different radio access technologies (RATs). For example, an upper 6 GHz band may be available for use by both 3GPP-based wireless communications networks and Wi-Fi-based wireless communications networks. Additionally, in some regions, such as Europe, the upper 6 GHz band is yet to be opened, and multiple different RATs are requesting to work on this band. In some cases, if multiple different RATs are able to use a particular band, one type of RAT may have priority to the shared radio frequency spectrum band, such as a 3GPP-based wireless communications network having priority over a Wi-Fi-based wireless communications network. Further, in some cases a RAT that has priority in a shared radio frequency spectrum band may change based on certain conditions, such as Wi-Fi-based wireless communications networks having priority for indoor settings or at large venues (such as stadiums), and 3GPP-based wireless communications networks having priority otherwise. In some cases, devices operating in shared radio frequency spectrum may perform listen-before-talk (LBT) procedures to confirm that a frequency band is not occupied prior to using the band. However, LBT techniques may not provide information related to particular devices using the frequency band, or provide an indication of whether a device has priority in the frequency band and what type of action a lower priority device is to take. Further, signaling, waveforms, or both for two different RATs may not be common, and devices associated with a first RAT may be unable to directly identify a presence of a device of a second RAT based on signaling associated with the second RAT.

Various aspects relate generally to coexistence strategies for different wireless communications networks associated with different RATs that may use a same shared radio frequency spectrum band. Some aspects more specifically relate to Wi-Fi devices (such as an AP) that may detect a signal from a device of a different RAT (such as a cellular or 3GPP-based RAT) and perform one or more adjustments to communications using the shared frequency band. In some examples, a cellular-based wireless device, such as a network entity, may transmit a message according to an uplink relaying protocol (such as the IEEE 802.11bc uplink relaying protocol) to inform an AP about its presence in a shared frequency band. In some such examples, an AP may operate in accordance with a first RAT, and a device of a second RAT (such as a network entity associated with a cellular or 3GPP-based RAT) may transmit an enhanced broadcast services (EBCS) uplink frame that indicates a presence of the device of the second RAT in a shared frequency band. In some examples, a network entity may embed instructions within the EBCS message that direct the AP to a cloud server to get instructions on how to operate in the shared frequency band. In some examples, one or more address fields of the EBCS uplink frame may be set to values that are unique to a deployment, an operator, or a particular use case, which may allow the receiving AP to quickly filter the frame. In some examples, a periodicity of EBCS uplink transmissions may be set to allow APs to perform monitoring at known intervals.

In some examples, the EBCS frame includes a frame transmit time field and a frame count field, which may enable protection from replay attacks. For example, an AP receiving the EBCS frame may perform a validation of the frame in accordance with the values carried in the frame transmit time and frame count fields. Additionally, or alternatively, in some examples a receiving AP may be configured with the operator's certificate that may be compared with a STA certificate field of the EBCS uplink frame to verify the frame. In some examples, if the EBCS uplink frame is verified, the AP may forward a payload of the EBCS uplink frame to a destination universal resource indicator (URI), or other address, provided in the EBCS uplink frame. In some such examples, the AP may receive a response from the destination URI or other address that indicates how the AP is to operate in the shared frequency band, and may adjust operation in the shared frequency band accordingly (such as by performing a power backoff or vacating the channel). Additionally, or alternatively, an some examples, a network entity may provision a UE to broadcast EBCS uplink frames under certain conditions, such as scenarios in which interference may be present between the network entity and the receiving AP. Additionally, or alternatively, in some examples, the network entity may transmit the EBCS uplink frame on a preferred scanning channel (PSC) of the receiving AP, and the receiving AP may monitor the PSC for the EBCS uplink frame, where the PSC may be a portion of an operating bandwidth of the receiving AP.

Particular aspects of the subject matter described in this disclosure can be implemented to realize one or more of the following potential advantages. In some examples, by monitoring for EBCS uplink frames to indicate presence of a device of a different RAT in a shared frequency band, an AP can efficiently and reliably detect the presence of the other device of the different RAT. Further, the information provided via the detected EBCS uplink frames may allow a receiving AP to determine whether devices of the different RAT have priority on the shared frequency band and adapt communications based on the determination. Additionally, by validating EBCS uplink frames, a receiving AP may avoid potential replay attacks, which may provide for more reliable and secure determinations of a presence of a network entity on a shared frequency band. Further, transmission of an EBCS uplink frame on a PSC may allow the receiving AP to monitor only a portion of its operating bandwidth, which may allow for other communications on other channels, and reduced power consumption by not monitoring channels other than the PSC.

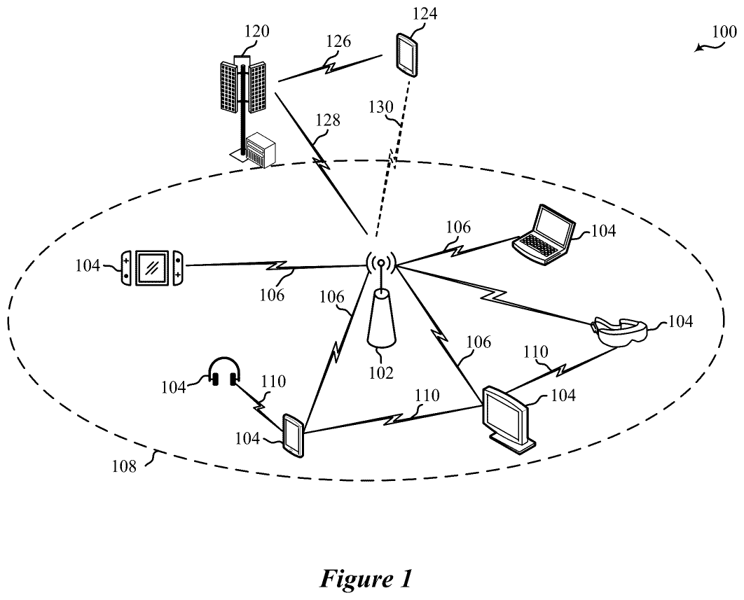

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

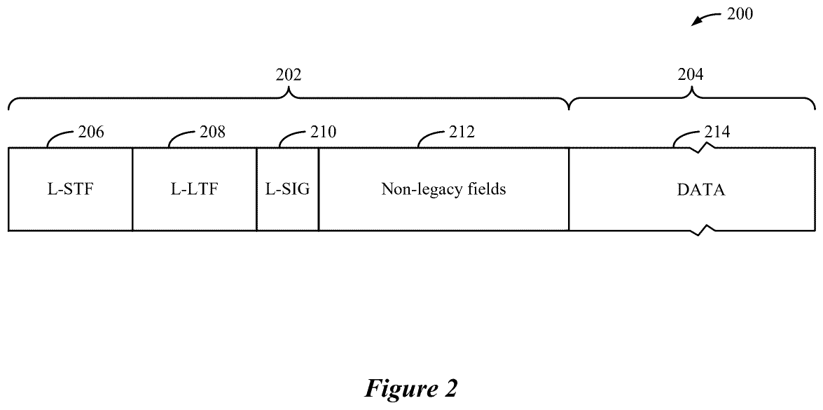

In some implementations, wireless communication network 100 may operate in a shared radio frequency spectrum band (such as an upper 6 GHz band) that is available to multiple different RATs, such as Wi-Fi operators and cellular operators (such as networks that operate based on 3GPP-based communications standards). In some examples, a network entity 120 of a cellular network and the AP 102 may both operate using a shared frequency band, where the cellular network has priority over the Wi-Fi network on the frequency band. In accordance with various aspects, the network entity 120 may transmit a message via a communication link 128 according to an uplink relaying protocol (such as IEEE 802.11bc uplink relaying protocol) to inform the AP 102 about its presence in the shared frequency band. In some implementations, the network entity 120 may transmit an EBCS uplink frame that indicates a presence of the network entity 120 on the shared frequency band. In some examples, the network entity 120 may embed instructions within the EBCS message, and/or direct the AP 102 to a cloud server, to provide instructions on how the AP 102 is to operate on the shared frequency band. In some implementations, the network entity 120 may communicate with an associated UE 124 via a cellular link 126, and may provision the UE 124 to transmit an EBCS uplink frame via communication link 130. Various examples of such techniques are discussed in more detail with reference to FIGS. 2 through 11.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (for example, packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

The auxiliary radio may support both transmitting and receiving (Tx/Rx) modes of operation, or may support receiving-only (Rx-only) modes of operation. If the wireless communication device is an MLD, the wireless communication device may communicate on one or more wireless links using a main radio and may simultaneously communicate on one or more wireless links using one or more auxiliary radios. In an MLD scenario in which the auxiliary radio is Rx-only capable (an “Aux-Rx” mode), the wireless communication device may transmit and receive communications on a first wireless link using the main radio but may simultaneously receive (but not transmit) communications on a second wireless link using the auxiliary radio. In an MLD scenario in which the auxiliary radio is Tx/Rx capable (an “Aux-Tx/Rx” mode), the wireless communication device may transmit and receive communications on a first wireless link using the main radio and may simultaneously transmit and receive communications on a second wireless link using the auxiliary radio. In an MLD scenario, the wireless communication device may transition the main radio from a second wireless link to a first wireless link and may correspondingly transition the auxiliary radio from the first wireless link to the second wireless link. For example, the wireless communication device's auxiliary radio may receive control signaling on the second wireless link from another wireless communication device that triggers the wireless communication device to switch the use of its radios between wireless links. If the wireless communication device is not an MLD, the wireless communication device may transition from using its auxiliary radio to using its main radio mode on a single wireless link. For example, the wireless communication device's auxiliary radio may receive control signaling from another wireless communication device that triggers the wireless communication device to initiate the transition from use of the auxiliary radio to the main radio on the wireless link. Upon such a transition, the wireless communication device may place the auxiliary radio in a powered-down sleep state while activating the main radio to an awake state. Similarly, the wireless communication may transition from using its main radio to its auxiliary radio on the wireless link upon receiving a triggering control signal.

In some examples, the wireless communication device (such as a STA) may indicate (for example, via a broadcast frame such as a beacon frame or other management frame), to other wireless communication devices (such as an AP), parameters associated with an auxiliary radio mode or parameters associated with transitioning from the auxiliary radio mode to a main radio mode for a given wireless link. For example, the wireless communication device may indicate a message format for the auxiliary radio mode. The indicated message format may be associated with a particular PPDU format (such as non-HT) or a supported data rate (such as ≤24 Mbps).

In some examples, the wireless communication device may indicate transition delays corresponding to time durations associated with switching from the auxiliary mode to the main radio mode as well as switching from the main radio mode to the auxiliary radio mode for a wireless link. A second wireless communication device may schedule data communications with the wireless communication device based on the transition delay so that data is not transmitted to the wireless communication device during the transition delay, during which data may be lost. The duration of the transition delay may generally be dependent on whether the auxiliary radio supports Tx/Rx or Rx-only modes of operation. For example, if the auxiliary radio supports Tx/Rx, the auxiliary radio may transmit an acknowledgment message in response to a request to transition to the main radio mode for a wireless link, which may extend the transition delay. Additionally, or alternatively, the duration of the transition delay may depend on whether the main radio is transitioning from a sleep mode or from a different wireless link.

The auxiliary radio may perform additional functions while the wireless communication device communicates with a second wireless communication device via a wireless link using the main radio. The functions that may be performed may generally depend on whether the auxiliary radio supports Tx/Rx or Rx-only modes of operation or whether the wireless communication device is an MLD capable of supporting communications over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communications or high-priority or otherwise important data communications from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communications or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

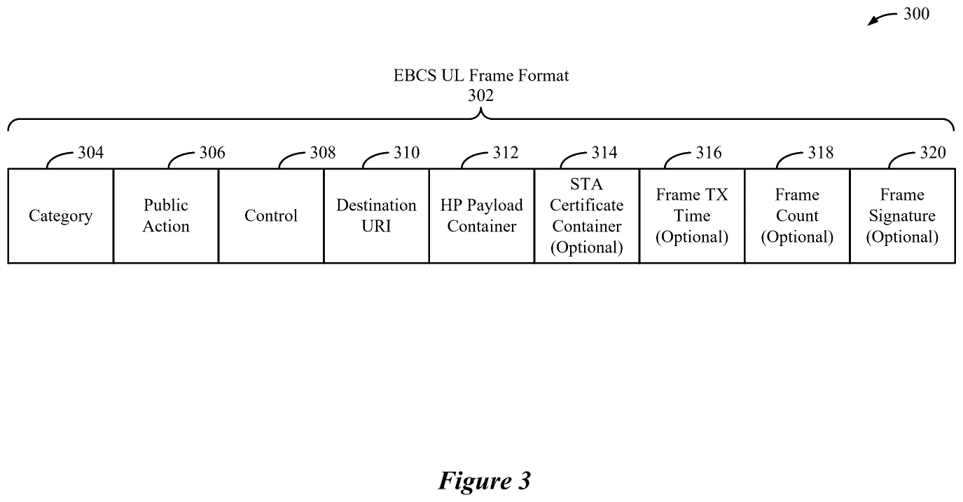

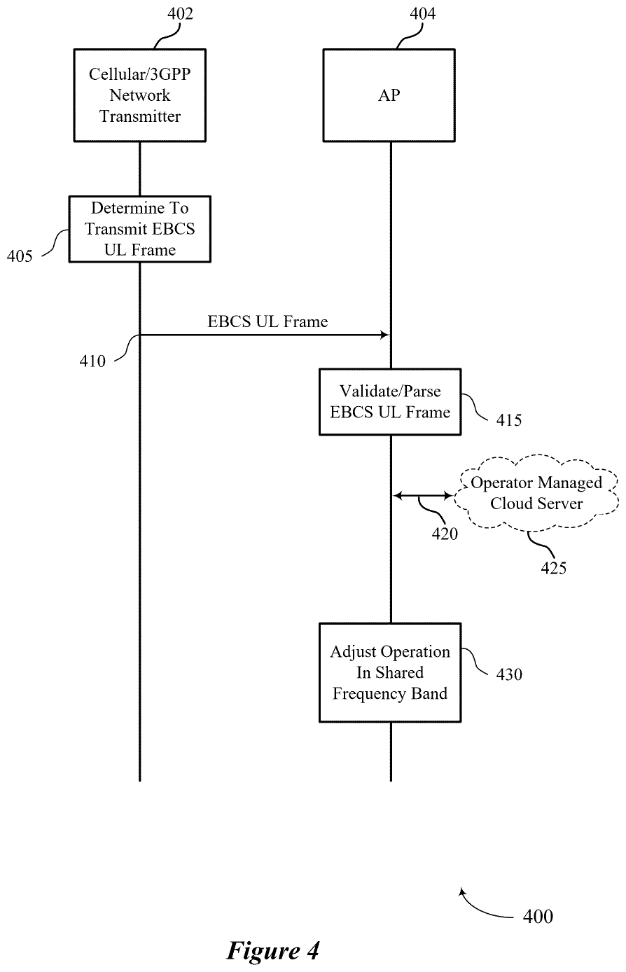

FIG. 3 shows an example of an EBCS frame 300 that supports coexistence strategies for different wireless communications networks that use shared radio frequency spectrum. In this example, EBCS frame 300 may be transmitted by a wireless device of a cellular network, such as a network entity or a UE, in accordance with coexistence techniques that provide for efficient and reliable signaling for wireless devices of different RATs to use a same shared frequency band. The network entity and UE may be examples of the network entity 120 and UE 124 as described with reference to FIG. 1, and as described with reference to FIGS. 4 through 11. The EBCS frame 300 may be transmitted in a PPDU that is able to be received and decoded by an AP.

In the example of FIG. 3, the EBCS frame 300 may be transmitted in accordance with a EBCS uplink frame format 302 that includes a category field 304 (which may be a 1 octet field), a public action field 306 (which may be a 1 octet field), a control field 308 (which may be a 1 octet field), a destination URI field 310 (which may be a variable length field), a higher layer protocol (HLP) payload container 312 (which may be a variable length field), an optional STA certificate container 314 (which may be a variable length field), an optional frame transmit time field 316 (which may be a 0 or 4 octet field), an optional frame count field 318 (which may be a 0 or 6 octet field), and an optional frame signature field 320 (which may be a variable length field).

In some implementations, the EBCS frame 300 may be transmitted by a network entity of a cellular network, or another transmitting device of the cellular network, such as a gNodeB, a UE, a radio head, a base station, and the like. The EBCS frame may be provided as part on an EBCS relaying service, which provides a mechanism for an EBCS non-AP STA to transmit an unsolicited EBCS uplink frame containing HLP payload container 312 that is intended to be relayed (such as by one or more EBCS relaying STAs) to a destination specified in the EBCS frame 300 (such as indicated in the destination URI field 310. Thus, in such implementations, the transmitting device of the cellular network may act as a non-AP STA, and the EBCS relaying AP may provide the relaying service to a non-AP STA regardless of its associated state with the AP. Further, a non-AP STA is not required to be in associated state with any AP or monitor the medium to discover APs that support relaying. In some examples, the EBCS frame 300 may include an indication of an operating bandwidth of the network entity. Such an indication may be provided in a PPDU that carries the EBCS frame, and may be included anywhere within the PPDU, such as the PPDU header, the MAC header of the EBCS frame, or a field within the EBCS frame.

In some implementations, the AP that receives the EBCS frame 300 may perform certain checks before it relays the HLP payload, based on one or more security parameters that may be included in the EBCS frame 300. In some examples, the AP may perform an authentication the source of the frame. In some examples, the EBCS frame 300 may include a timestamp in the frame transmission time field 316, which may be used to reduce the possibility of a replay attack. The timestamp may include a time, in seconds, since Jan. 1, 2020, 00:00:00 UTC, plus an incrementing counter, that indicates a time at which the EBCS frame 300 was queued for transmission. The EBCS frame may also include the STA certificate container 314, which may provide a certificate for authentication, where a certification may be signed by the intended cloud provider or a certificate authority, and a signature of the frame using the STA's certificate in the frame signature field 320. To verify the integrity of the contents of the EBCS frame 300, the receiving AP, in some examples, may compare the timestamp with a local time (such as a time that is maintained within an accuracy of one second) and may discard the EBCS frame 300 if a difference between the timestamp and the local time exceeds a certain value (such as one second). Additionally, or alternatively, the receiving AP may be provisioned with the operator's certificate of the cellular network, and a certificate provided in the STA certificate container 314 may be verified at the AP itself or based on a lookup of the certificate at a server of the destination URI.

FIG. 4 shows an example of a signaling diagram 400 that supports coexistence strategies for different wireless communications networks that use shared radio frequency spectrum. The signaling diagram 400 includes cellular/3GPP network transmitter 402 (such as a gNodeB, a network entity, or a UE), and an AP 404. The cellular/3GPP network transmitter 402, and the AP 404, may be examples of the APs and network entities as described herein with respect to FIGS. 1-3. The signaling diagram 400 illustrates example operations and signaling for a EBCS uplink frame transmissions that indicate that a network entity is operating in a frequency band that may be shared between the cellular/3GPP network transmitter 402 and the AP 404.

As described herein, the wireless communication devices may implement techniques in which an EBCS uplink frame may be used to indicate that the AP 404 is to adapt communications using the shared frequency band, such as by vacating the channel or operating at a reduced transmit power, which may provide for efficient and reliable indications of transmitter priority in a shared frequency band, and enhance overall use and efficiency of communications by multiple different RATs on the shared frequency band. In the example of FIG. 4, the cellular/3GPP network transmitter 402 may determine, at 405, to transmit an EBC uplink frame. In some implementations, the cellular/3GPP network transmitter 402 may periodically transmit such a frame while operating on the shared frequency band to announce its presence and allow devices that do not have priority in the frequency band to adjust their communications to accommodate the higher priority transmissions. At 410, the cellular/ 3GPP network transmitter 402 may transmit, and the AP 404 may receive, the EBCS uplink frame. As discussed herein, the EBCS uplink frame may include multiple fields, and at 415 the AP 404 may validate and parse the EBCS uplink frame. As discussed herein, the validation may be based on a timestamp provided in the EBCS uplink frame, an operator signature provided in the EBCS uplink frame, a frame count provided in the EBCS uplink frame, a frame signature provided in the EBCS uplink frame, or any combination thereof.

At 420, in some implementations, upon validation of the EBCS uplink frame the AP 404 may communicate with an operator managed cloud server 425 to determine whether the AP 404 should adjust its operation in the shared frequency band. In some implementations, a URI provided in the EBCS frame may be used to contact the operator managed cloud server 425. In other implementations, the EBCS uplink frame itself may include information, such as in a HLP payload, that indicates how the AP 404 is to adjust its operation in the shared frequency band. In some implementations, the EBCS frame may include an indication of an operating bandwidth of the cellular/3GPP network transmitter 402, and the AP 404 may use this information to determine adjustments to its operation. At 430, the AP 404 may adjust its operation in the shared frequency band in accordance with the information provided by the operator managed cloud server 425 or in accordance with the information in the HLP payload of the EBCS uplink frame.

Thus, in some implementations, the cellular/3GPP network transmitter (such as a network entity, a gNodeB, or a UE), when operating in the shared frequency band (such as the upper 6 GHz band that may be available for use by multiple different RATs with one RAT having priority over another RAT), will act as an EBCS non-AP STA. In some implementations, the EBCS non-AP STA may periodically broadcast the EBCS uplink frame. In some aspects, the EBCS uplink frame may include one or more address fields (such as the A1 and A3 address fields) that may be set to values that are unique to a deployment, an operator, or for a particular use case (such as indoor versus outdoor deployments), which may help the receiving AP 404 to efficiently filter the frame. In some implementations, the periodicity of EBCS uplink transmission, or a periodicity based on a particular use case, may be standardized or determined by regulatory bodies. In cases where such EBCS frames are used to indicate operation in a shared frequency band, an AP, such as AP 404, that supports operating on the shared frequency band may support EBCS relaying service. As discussed herein, in some aspects the AP 404 may validate a received EBCS uplink frame. In some implementations, validation may be based on a timestamp of when the EBCS frame was queued for transmission, and the AP 404 may maintain a clock with a predetermined accuracy (such as one second or better), which may be used to compare a timestamp in the EBCS uplink frame, and if a difference between the timestamp and the AP 404 clock exceeds a threshold value, the EBCS frame may be discarded. Such a validation may help prevent replay attacks using the EBCS uplink frame. Additionally, or alternatively, the EBCS frame may include a frame transmit time and a frame count field to provide protection from replay attack. In such implementations, the receiving AP 404 may perform an initial validation of the frame based on the values carried in the frame transmit time field and the frame count field to verify replay does not appear to be present. As discussed herein, in some aspects the time expressed in the frame transmit time field may be the number of seconds since Jan. 1, 2020, 00:00:00 UTC, when the frame is queued for transmission. In some implementations, such validation at the AP 404 may be skipped, and may be performed directly at the operator managed cloud server 425. Additionally, or alternatively, some systems may provide that APs may be provisioned with the operator's certificate. In such implementations, the certificate may be carried in the STA certificate field and verified by the AP 404. For example, the AP 404 may looks up the operator certificate based on the destination URI (or the address field(s)), or a combination thereof, provided in the EBCS frame. If the initial validation is successful, in some implementations the AP 404 may forward the HLP to cloud server 425, which may authenticate the cellular/3GPP network transmitter 402 based on the contents of the HLP. In some examples, the HLP payload may carry information to authenticate of the cellular/3GPP network transmitter 402, and the frame signature field may be absent in this case. If the authenticity of the EBCS uplink frame transmitter is successfully confirmed, the cloud server 425 may provide directives to the AP 404, such as to vacate the channel or to operate at a reduced transmit power. In some implementations, the AP 404 may have a relationship with the operator, which may provide a mechanism for the AP 404 to validate the message from the operator's cloud server 425 before executing the directive.

Additionally, or alternatively, the destination URI in the EBCS uplink frame may point to a special address (such as an address defined by a standard, or regulatory body, or specified for a region). This option may provide that the AP 404 is provisioned with the necessary (security) credentials to validate cellular/3GPP network transmitters 402 from various operators. In some implementations, detection of the special address may indicate to the AP 404 that the payload of the EBCS uplink frame does not need to be relayed to a destination address, and the AP 404 may determine actions (such as power back off or vacating the channel) without forwarding any portion of the EBCS uplink frame to a different entity (such as a cloud server). In some implementations, it is possible that the security credentials may updated relatively frequently, such as via a network update or firmware upgrade. In some examples, the special address may indicate that the contents of the HLP payload are to be parsed by the AP 404 itself, with no relaying of the payload. In some implementations, different values of the special address indicate different things to the AP 404. For example, values of the special address may be different for different deployment locations (such as different locations in which the AP 404 may have priority over the cellular/3GPP network transmitters 402, or vise-versa), can be operator specific, or be a single value defined by a standard. In one example, a first value of the special address of the destination URI may indicate that the AP 404 is vacate the channel (such as by moving to a different channel), a second value of the special address may indicate that the AP 404 is to stop operation (such as by discontinuing operation in all channels of the shared frequency band), and a third value of the special address may indicate that the AP 404 is to reduce transmit power. Additionally, or alternatively, the HLP payload in some examples carries instructions for the AP 404, which may perform validation and authentication before executing the instructions. In some implementations, the AP 404 may use the provisioned (security) credentials to authenticate the operator/transmitter and validate that the EBCS uplink frame signature to verify that the contents of the frame have not been tampered with. In some implementations, the frame signature may be validated by a higher layer at the AP 404. Additionally, or alternatively, the frame transmit time and frame count fields may be used to help verify replay. Once validated, the AP 404 may execute the action indicated by the EBCS uplink frame, such as to vacate the channel or to operate at reduced transmit power.

As discussed herein, in some implementations the EBCS uplink frame may be transmitted by a UE. For example, a cellular operator may allow a UE to broadcast EBCS uplink under certain conditions, such as if the network entity is experiencing a packet error rate (PER) above a threshold value for uplink communications due interference from Wi-Fi, for example. In such implementations, the UE may be provisioned by the network entity with the appropriate security credentials so that the AP 404 (and/or the cloud server 425) can authenticate, validate and honor the request. In some examples, such UEs may be configured with a time validation at the AP 404 (such as a frame transmit time) to prevent a UE from abusing such operation (such as by replaying the message later to the same or different AP). In some implementations, the message from a UE may have a relatively short validity. For example, the credentials provided to the UE may not be reused, or are valid for a short period of time (such as one or a few seconds). In some examples, a network entity may provide the EBCS uplink frame and the UE may blindly transmit the frame without making any modifications. In implementations where a UE may transmit an EBCS uplink frame, the various techniques and considerations as discussed herein related to how, where and when to transmit a an EBCS uplink frame, may also apply to such a UE.

In some examples, the AP 404 may monitor for an EBCS uplink frame at an initial setup of the BSS. In such examples, the AP 404 may scan different channels before settling on a clean channel to operate its BSS. Further, the AP 404 may also scan adjacent channels before it sets-up its BSS. Such a mechanism lends itself for detecting EBCS uplink frames and selecting an operating bandwidth in accordance with any detected EBCS uplink frames. In some implementations, address fields (such as A1/A3 fields in the EBCS uplink frame) can help the AP 404 to filter for EBCS uplink frames from a cellular network or a transmitter from some other RAT. In some implementations, the dwell times when scanning a preferred scanning channel (PSC) at the AP 404 may be selected such that they are greater than the periodicity of the EBCS uplink transmissions. Further, subsequent to the initial scan before setting up the BSS, the AP 404 may perform periodic scans to check if a transmitter has been activated in the neighborhood. In cases where a transmitter with priority in the shared frequency band is detected, the AP 404 may vacate the channel, reduce its transmit power, or apply puncturing in cases of narrow or partial overlap.

In some examples, a cellular/3GPP network transmitter 402 may be enabled after the AP 404 has set up its BSS. In such examples, the AP 404 may perform monitoring for EBCS uplink frames while also communicating with one or more associated STAs. In some examples, the AP 404 may go off-channel to scan for EBCS uplink frames. In such examples, the AP 404 may signal its unavailability on the primary channel so that associated STAs do not attempt any uplink transmissions during the AP 404 absence. In some examples, the AP 404 may signal quiet periods in BSS. For example, the AP 404 may broadcast unavailability signaling, may advertise link disablement, or signal unavailability such as through dynamic power save or coexistence signaling. In other examples, if available, the AP 404 may use an auxiliary radio to monitor the BSS's subchannels for an EBCS uplink frame. In some examples the auxiliary radio may be moved (such as in a round-robin fashion) to different channels to scan for the EBCS signal, such as different PSCs and/or secondary channels). In some implementations, the auxiliary radio may have limited capability, and the address fields (A1/A3) can help the AP 404 filter for EBCS UL frames. Additionally, or alternatively, in some examples the AP 404 may request its associated STA(s) to scan a PSC for EBCS uplink frames. For example, the AP 404 may use a frame request/report mechanism to indicate associated STA(s) are to scan for EBCS uplink frames. In some examples, the AP 404 may filter through the report to determine if an EBCS uplink frame was received (such as based on the A3/BSSID) by the designated STA on the directed PSC. If detected, the AP 404 may perform a scan to receive and decode the frame.

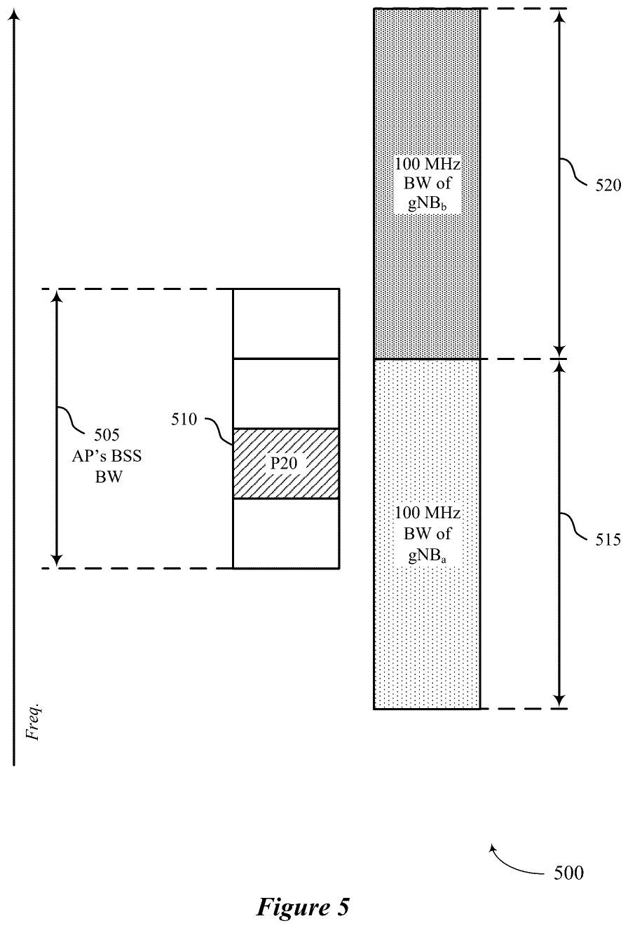

FIG. 5 shows an example of a channel bandwidth 500 of an AP and a network entity that supports coexistence strategies for different wireless communications networks that use shared radio frequency spectrum. In this example, an AP and network entity may operate in associated channel bandwidths of a shared radio frequency spectrum band. The network entity and AP may be examples of the network entity 120 and AP 102 as described with reference to FIG. 1, or the network entity 402 and AP 404 as described with reference to FIG. 4. The network entity and AP may operate in accordance with coexistence techniques that provide for efficient and reliable signaling for wireless devices of different RATs to use a same shared frequency band.

In the example of FIG. 5, the AP may configure a BSS that operates in bandwidth 505, which may be an 80 MHz bandwidth that include four 20 MHz channels. Further, the AP may have a primary 20 MHz channel 510 (a P20 channel). Additionally, in this example, a first network entity (such as gNodeBₐ) may operate in a first 100 MHz bandwidth 515, and a second network entity (such as gNodeB_{b}) may operate in a second 100 MHz bandwidth 520. In some cases, the bandwidth 505 may span between two adjacent network entity bandwidths, as illustrated in FIG. 5. In some implementations, the first network entity and the second network entity may be associated with different operators. In accordance with various aspects, an AP may monitor for EBCS uplink frames in both the first 100 MHz bandwidth 515 and the second 100 MHz bandwidth 520, in order to comply with priority rules in which the network entities have priority in the shared frequency band.

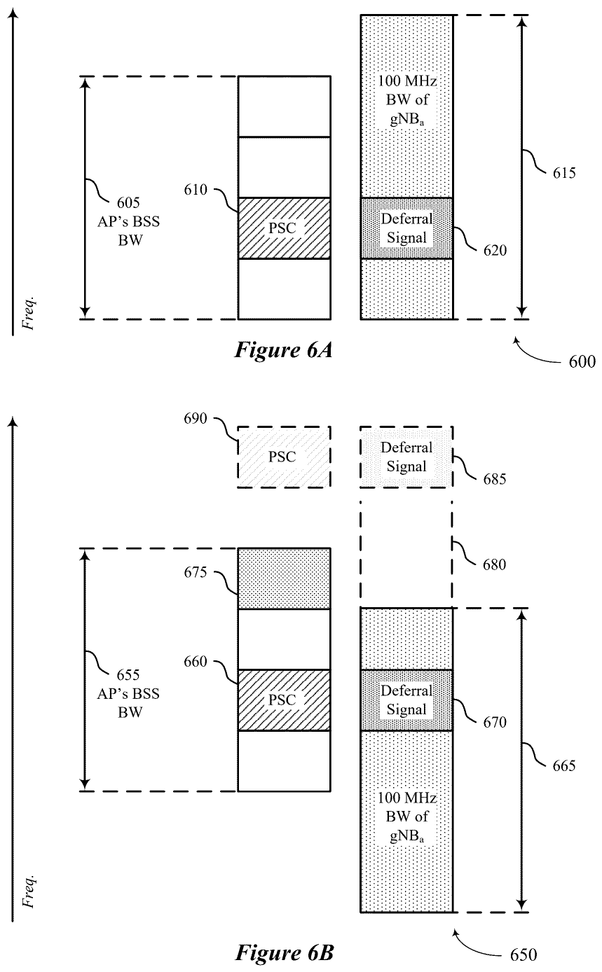

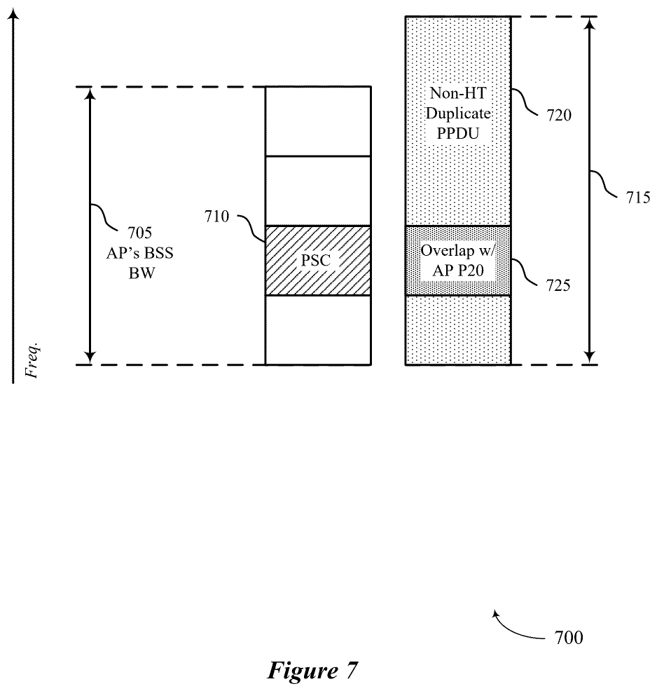

In some implementations, the network entities may transmit the EBCS uplink frame, which may also be referred to as a deferral signal, on a PSC that corresponds to the primary 20 MHz channel 510 of the AP. In some examples, network entities may broadcast the deferral signal (EBCS UL frame) on a PSC within its operating bandwidth, and the HLP payload may provide information about the network entities bandwidth so that the AP can identify the overlapping channels. Further, in some implementations the AP and network entity may accommodate situations where the AP has not setup its BSS on the PSC or the AP has partial overlap with a network entity such that PSC does not lie within the overlapping portion of the AP bandwidth 505 and the first 100 MHz bandwidth 515 or the second 100 MHz bandwidth 520. Such implementations are discussed with reference to the examples of FIGS. 6A, 6B, and 7.

FIGS. 6A and 6B show examples of preferred scanning channels in 100 MHz channel bandwidths 600 and 650 of a network entity that supports coexistence strategies for different wireless communications networks that use shared radio frequency spectrum. In this example, an AP and network entity may operate in associated channel bandwidths of a shared radio frequency spectrum band. The network entity and AP may be examples of the network entity 120 and AP 102 as described with reference to FIG. 1, or the network entity 402 and AP 404 as described with reference to FIG. 4. The network entity and AP may operate in accordance with coexistence techniques that provide for efficient and reliable signaling for wireless devices of different RATs to use a same shared frequency band.

In the example of FIG. 6A, the AP may configure a BSS that operates in bandwidth 605, which may be an 80 MHz bandwidth that include four 20 MHz channels. Further, the AP may have a primary 20 MHz channel 610 (a PSC). In this example, a first network entity may operate in a first 100 MHz bandwidth 615, and the AP bandwidth 605 may fully overlap with the first 100 MHz bandwidth 615. In such examples, the network entity may transmit a deferral signal 620 (such as an EBCS frame) in a channel that corresponds to the primary 20 MHz channel 610. The AP may thus monitor the primary 20 MHz channel 610 and detect deferral signal 620.

In the example of FIG. 6B, the AP may configure a BSS that operates in bandwidth 655, which may be an 80 MHz bandwidth that include four 20 MHz channels. Further, the AP may have a primary 20 MHz channel 660 (a PSC). In this example, a first network entity may operate in a first 100 MHz bandwidth 665, and the AP bandwidth 605 does not fully overlap with the first 100 MHz bandwidth 665, but instead partially overlaps with a second 100 MHz bandwidth 680, such that a 20 MHz channel 675 of the AP bandwidth 655 overlaps with the second 100 MHz bandwidth 680 and remaining portions of the AP bandwidth 655 overlap with the first 100 MHz bandwidth 665, including the primary 20 MHz channel 660. In such examples, the first network entity may transmit a deferral signal 670 (such as an EBCS frame) in a channel that corresponds to the primary 20 MHz channel 660, but the second network entity may transmit its associated deferral signal 685 in a different primary 20 MHz channel 690. In some implementations, such an issue may be addressed by having the AP scan adjacent PSCs, such as corresponding to the different primary 20 MHz channel 690, in addition to the primary 20 MHz channel 660 within the AP bandwidth 655.

Additionally, or alternatively, if the operator(s) of the first and second network entities share a common radio, and/or if the system allows and the network entity capabilities support, a network entity can transmit its deferral signal on adjacent PSCs in addition to the PSC within its own bandwidth. In some further examples, additionally, or alternatively, there may be a common channel, which may or may not overlap with primary 20 MHz channel 660, where active network entities may transmit their deferral signals. The location of the common channel may be provided in a standard, defined by local regulations, or may be specific to an operator or a location or a deployment scenario. In such examples, the Wi-Fi APs may be configured to scan the common channel, directly or via a proxy such as an associated STA or auxiliary radio, to determine the presence of network entities and a channel map that can be determined based on deferral signals on the common channel. In still further implementations, such as discussed with reference to FIG. 7, network entities may transmit deferral signals to indicate their presence on shared radio frequency spectrum.

FIG. 7 shows an example of channel bandwidth 700 of an AP and a network entity that supports coexistence strategies for different wireless communications networks that use shared radio frequency spectrum. In this example, an AP and network entity may operate in associated channel bandwidths of a shared radio frequency spectrum band. The network entity and AP may be examples of the network entity 120 and AP 102 as described with reference to FIG. 1, or the network entity 402 and AP 404 as described with reference to FIG. 4. The network entity and AP may operate in accordance with coexistence techniques that provide for efficient and reliable signaling for wireless devices of different RATs to use a same shared frequency band.

In the example of FIG. 7, the AP may configure a BSS that operates in bandwidth 705, which may be an 80 MHz bandwidth that include four 20 MHz channels. Further, the AP may have a primary 20 MHz channel 710 (a PSC). Additionally, in this example, a first network entity may operate in a first 100 MHz bandwidth 715. In some implementations, the first network entity may transmit a non-high-throughput (non-HT) duplicated PPDU 720 in the first 100 MHz bandwidth 715 that carries the EBCS uplink frame. In such implementations, the AP that is operating on the primary 20 MHz channel 710, or on another channel within the AP bandwidth 705, may receive the frame. In some examples, a SERVICE field of the non-HT duplicated PPDU 720 may carry bandwidth information related to the PPDU so that the receiving AP knows the bandwidth of the transmission. In some examples, the bandwidth information may be provided in a bandwidth signaling transmitter address (TA). In some implementations, the non-HT duplicated PPDU 720 may provide a EBCS uplink frame using duplicated channels that include an overlapping channel 725 with the primary 20 MHz channel 710. In cases where the APs primary 20 MHz channel 710 does not overlap with the first 100 MHz bandwidth 715, the AP may supplement monitoring for the EBCS uplink frame such as by using techniques as discussed with reference to FIGS. 6A and 6B.

In some implementations, a network entity may transmit an EBCS uplink frame in a PPDU that duplicates a preamble on 20 MHz subchannels. For example, the network entity may use a preamble setting for an extremely high throughput (EHT) PPDU that indicates duplication of 20 MHz, such as by providing a UL/DL indication (B6 of U-SIG-1) set to 1 (to indicate PPDU is addressed to an AP); a BSS Color (B7-B12 of U-SIG-1) set to 0; a PPDU Type & Compression Mode (B0-B1 of U-SIG-2) set to 1 (EHT SU) (that indicates the preamble of the EHT SU transmission is duplicated across 20 MHz subchannels of the transmission bandwidth); a STA-ID (B0-B10 of User Info field) set to broadcast (such as 0 or 2045); and a bandwidth of the PPDU determined based on B3-B5 of the U-SIG-1 field. In other examples, the network entity may use a preamble setting of a high efficiency (HE) SU PPDU that indicates preamble duplication across 20 MHz subchannels, such as by providing a PPDU format set to HE SU (B0 of HE-SIG-A set to 1); a UL/DL indicator (B2 of HE-SIG-A) set to 1 to indicate PPDU is addressed to an AP; a BSS Color (B8-B13 of HE-SIG-A) set to 0; and a bandwidth of the PPDU determined based on B9-B20 of HE-SIG-A field. In such examples, a PPDU can be decoded by an AP that has its PSC within the PPDU's bandwidth, since the HE or EHT preamble is duplicated on all 20 MHz subchannels of the PPDU's bandwidth. In cases where the APs PSC does not overlap with the PPDU bandwidth, the AP may supplement monitoring for the EBCS uplink frame such as by using techniques as discussed with reference to FIGS. 6A and 6B.

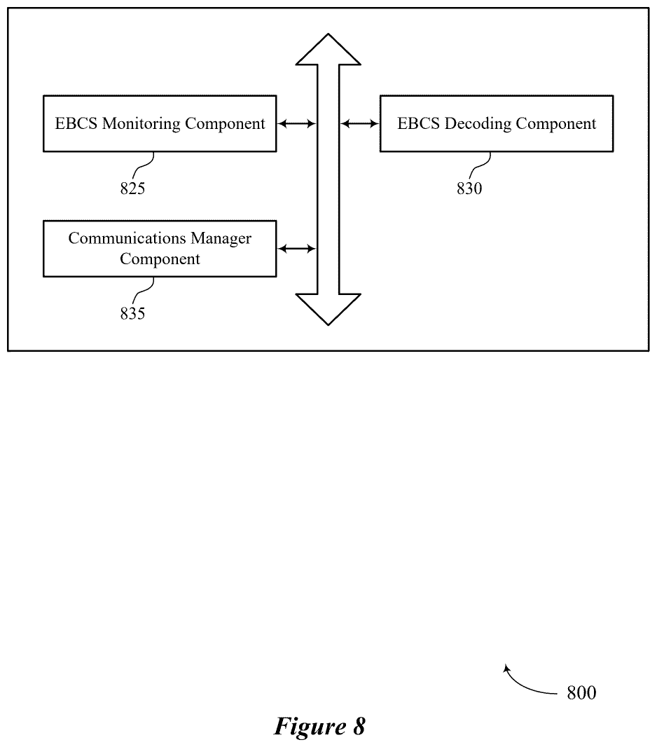

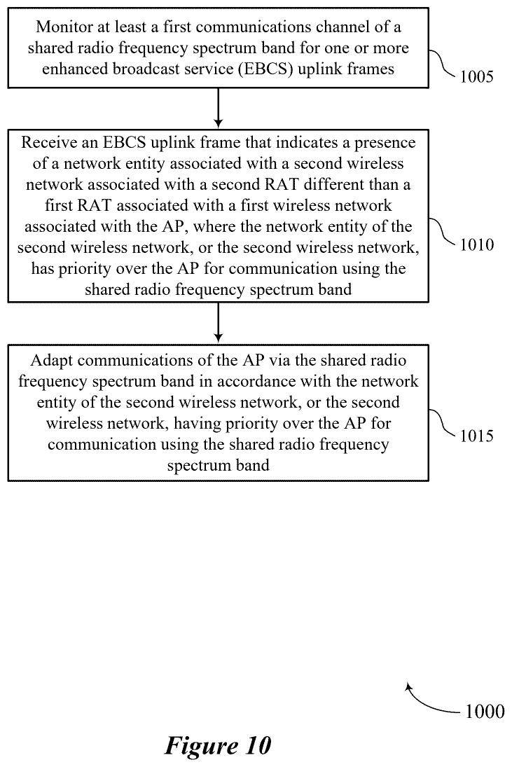

FIG. 8 shows a block diagram of an example wireless communication device 800 that supports coexistence strategies for different wireless communications networks that use shared radio frequency spectrum. In some examples, the wireless communication device 800 is configured to perform the process 1000 described with reference to FIG. 10. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in an AP, such as the AP 102 described with reference to FIG. 1. In some other examples, the wireless communication device 800 can be an AP that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes at least one external network interface coupled with the processing system that enables communication with a core network or backhaul network that enables the wireless communication device 800 to gain access to external networks including the Internet.

The wireless communication device 800 includes a EBCS monitoring component 825, a EBCS decoding component 830, and a communications manager component 835. Portions of one or more of the EBCS monitoring component 825, the EBCS decoding component 830, and the communications manager component 835 may be implemented at least in part in hardware or firmware. For example, one or more of the EBCS monitoring component 825, the EBCS decoding component 830, and the communications manager component 835 may be implemented at least in part by at least a processor or a modem. In some examples, portions of one or more of the EBCS monitoring component 825, the EBCS decoding component 830, and the communications manager component 835 may be implemented at least in part by a processor and software in the form of processor-executable code stored in memory.

The wireless communication device 800 may support wireless communications in accordance with examples as disclosed herein. The EBCS monitoring component 825 is configurable or configured to monitor at least a first communications channel of a shared radio frequency spectrum band for one or more enhanced broadcast service (EBCS) uplink frames. The EBCS decoding component 830 is configurable or configured to receive an EBCS uplink frame that indicates a presence of a network entity associated with a second wireless network associated with a second radio access technology (RAT) different than a first RAT associated with a first wireless network associated with the AP, where the network entity of the second wireless network, or the second wireless network, has priority over the AP priority over the AP for communication using the shared radio frequency spectrum band. The communications manager component 835 is configurable or configured to adapt communications of the AP via the shared radio frequency spectrum band in accordance with the network entity of the second wireless network, or the second wireless network, having priority over the AP for communication using the shared radio frequency spectrum band.

In some examples, the EBCS uplink frame is transmitted by a transmitter associated with the second wireless network that is acting as an EBCS STA of the first wireless network. In some examples, the second wireless network is a cellular network or a 3GPP-based network, and the first wireless network is a WLAN that operates in accordance with an IEEE 802.11 protocol. In some examples, the transmitter associated with the second wireless network is the network entity or a UE associated with the second wireless network. In some examples, the shared radio frequency spectrum band is an upper 6 GHz band that is shared by one or more cellular networks and one or more wireless local area networks. In some examples, monitoring at least the first communications channel of the shared radio frequency spectrum band is in accordance with a periodicity for transmission of the EBCS uplink frames that indicate the presence of the network entity of the second wireless network.

In some examples, the EBCS decoding component 830 is configurable or configured to determine, in accordance with one or more address fields of the EBCS uplink frame, that the EBCS uplink frame is associated with an indication of the presence of the network entity of the second wireless network. In some examples, the EBCS decoding component 830 is configurable or configured to decode a URI from the EBCS uplink frame. In some examples, the EBCS decoding component 830 is configurable or configured to obtain an indication from a server associated with the URI that the communications of the AP via the shared radio frequency spectrum band are to be adjusted, and one or more corresponding parameters associated with the communications of the AP via the shared radio frequency spectrum band.

In some examples, the EBCS decoding component 830 is configurable or configured to validate the EBCS uplink frame in accordance with a frame transmit time and a frame count value indicated by the EBCS uplink frame, and where the adapting is performed in accordance with the validated EBCS uplink frame.

In some examples, the EBCS uplink frame is validated in accordance with an operator certificate indicated by the EBCS uplink frame. In some examples, the EBCS decoding component 830 is configurable or configured to validate, in accordance with a predefined field value of a first field of the EBCS uplink frame, that the EBCS uplink frame is authentic. In some examples, the EBCS decoding component 830 is configurable or configured to parse, responsive to validation of the EBCS uplink frame, a payload of the EBCS uplink frame, where one or more parameters for adapting communications of the AP via the shared radio frequency spectrum band are indicated in the payload.

In some examples, the first communications channel is a preferred scanning channel of the AP within a basic service set bandwidth of the AP. In some examples, the EBCS monitoring component 825 is configurable or configured to monitor one or more other preferred scanning channels that are outside of the basic service set bandwidth of the AP for the EBCS uplink frame. In some examples, the first communications channel is a common channel that is within or outside of a basic service set bandwidth of the AP.

In some examples, the first communications channel is monitored in association with a procedure to identify an available frequency band for operation of the AP within the first wireless network, and where the first communications channel is monitored for a time period in accordance with a periodicity of transmissions of EBCS uplink frames.

In some examples, the communications manager component 835 is configurable or configured to communicate, prior to receiving the EBCS uplink frame, with one or more STAs that are associated with the AP using at least the first communications channel, and where the monitoring the first communications channel is performed periodically in accordance with a periodicity of transmissions of EBCS uplink frames.

In some examples, the first communications channel is outside of a basic service set bandwidth of the AP, and an indication is transmitted to one or more associated STAs that the AP is unavailable for communications during a monitoring instance of the first communications channel. In some examples, the first communications channel is outside of a basic service set bandwidth of the AP, and where the first communications channel is monitored using an auxiliary radio of the AP that is different than a primary radio used for communication with one or more associated stations (STAs) of the AP within the basic service set bandwidth.

In some examples, the communications manager component 835 is configurable or configured to communicate with one or more associated STAs via the shared radio frequency spectrum band. In some examples, the communications manager component 835 is configurable or configured to request one or more associated STAs to monitor for EBCS uplink frames. In some examples, the communications manager component 835 is configurable or configured to monitor the first communications channel based on receiving an indication of presence of at least one EBCS uplink frame from the one or more associated STAs. In some examples, the EBCS uplink frame is received in a non-HT duplicate PPDU.

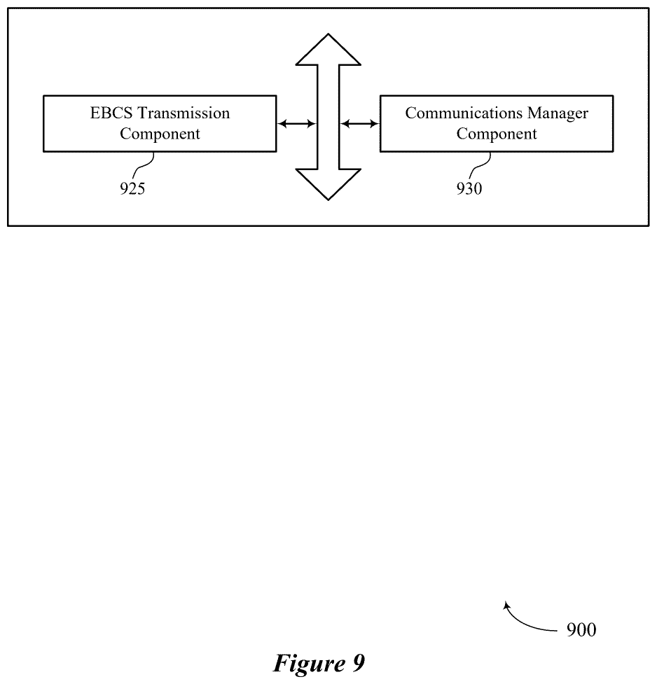

FIG. 9 shows a block diagram of a wireless communication device 900 that supports coexistence strategies for different wireless communications networks that use shared radio frequency spectrum in accordance with one or more aspects of the present disclosure. The wireless communication device 900 may be an example of aspects of a network entity as described with reference to FIGS. 2 through 7. The wireless communication device 900, or various components thereof, may be an example of means for performing various aspects of coexistence strategies for different wireless communications networks that use shared radio frequency spectrum as described herein. For example, the wireless communication device 900 may include a EBCS transmission component 925 a communications manager component 930, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 120, between devices, components, or virtualized components associated with a network entity 120), or any combination thereof.

The wireless communication device 900 may support wireless communications in accordance with examples as disclosed herein. The EBCS transmission component 925 is configurable or configured to transmit, to one or more APs associated with a first wireless network associated with a RAT different than a second RAT associated with a second wireless network associated with the network entity, on a first communications channel of a shared radio frequency spectrum band, one or more EBCS uplink frames that indicate a presence of communications of the network entity on at least a portion of the shared radio frequency spectrum band, where the network entity, or the second wireless network, has priority over the one or more APs for communication using the shared radio frequency spectrum band. The communications manager component 930 is configurable or configured to communicate with at least a first UE via at least the portion of the shared radio frequency spectrum band.

In some examples, the network entity acts as an EBCS STA of the first wireless network when transmitting the one or more EBCS frames. In some examples, the second wireless network is a cellular network or a 3GPP-based network, and the first wireless network is a WLAN that operates in accordance with an IEEE 802.11 protocol. In some examples, transmitting the one or more EBCS uplink frames is in accordance with a periodicity for transmission of EBCS uplink frames that indicate the presence of the network entity in the shared radio frequency spectrum band.

In some examples, the communications manager component 930 is configurable or configured to configure the first UE to transmit one or more EBCS uplink frames in accordance with a presence of one or more defined conditions at the UE. In some examples, the one or more defined conditions include a packet error rate for uplink communications of the first UE exceeding a threshold value due to interference associated with communications of the first wireless network. In some examples, the first UE is configured with one or more security credentials for authentication of the one or more EBCS uplink frames.

In some examples, the first communications channel is a preferred scanning channel within a basic service set bandwidth of the one or more APs. In some examples, the first communications channel is a common channel that is within or outside of a basic service set bandwidth of the one or more APs.

FIG. 10 shows a flowchart illustrating an example process 1000 performable by or at a wireless AP that supports coexistence strategies for different wireless communications networks that use shared radio frequency spectrum. The operations of the process 1000 may be implemented by a wireless AP or its components as described herein. For example, the process 1000 may be performed by a wireless communication device, such as the wireless communication device 800 described with reference to FIG. 8, operating as or within a wireless AP. In some examples, the process 1000 may be performed by a wireless AP, such as one of the APs 102 described with reference to FIG. 1.

In some examples, in 1005, the wireless AP may monitor at least a first communications channel of a shared radio frequency spectrum band for one or more enhanced broadcast service (EBCS) uplink frames. The operations of 1005 may be performed in accordance with examples as disclosed herein. In some implementations, aspects of the operations of 1005 may be performed by a EBCS monitoring component 825 as described with reference to FIG. 8.

In some examples, in 1010, the wireless AP may receive an EBCS uplink frame that indicates a presence of a network entity associated with a second wireless network associated with a second RAT different than a first RAT associated with a first wireless network associated with the AP, where the network entity of the second wireless network, or the second wireless network, has priority over the AP priority over the AP for communication using the shared radio frequency spectrum band. The operations of 1010 may be performed in accordance with examples as disclosed herein. In some implementations, aspects of the operations of 1010 may be performed by a EBCS decoding component 830 as described with reference to FIG. 8.

In some examples, in 1015, the wireless AP may adapt communications of the AP via the shared radio frequency spectrum band in accordance with the network entity of the second wireless network, or the second wireless network, having priority over the AP for communication using the shared radio frequency spectrum band. The operations of 1015 may be performed in accordance with examples as disclosed herein. In some implementations, aspects of the operations of 1015 may be performed by a communications manager component 835 as described with reference to FIG. 8.

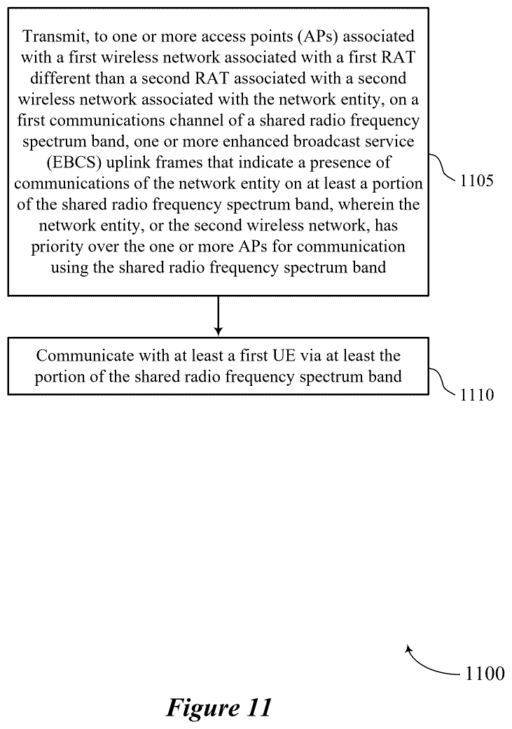

FIG. 11 shows a flowchart illustrating a method 1100 that supports coexistence strategies for different wireless communications networks that use shared radio frequency spectrum in accordance with one or more aspects of the present disclosure. The operations of the method 1100 may be implemented by a network entity or its components as described herein. For example, the operations of the method 1100 may be performed by a network entity as described with reference to FIGS. 2 through 7 and 9. In some examples, a network entity may execute a set of instructions to control the functional elements of the network entity to perform the described functions. Additionally, or alternatively, the network entity may perform aspects of the described functions using special-purpose hardware.

At 1105, the method may include transmitting, to one or more APs associated with a first wireless network associated with a first RAT different than a second RAT associated with a second wireless network associated with the network entity, on a first communications channel of a shared radio frequency spectrum band, one or more EBCS uplink frames that indicate a presence of communications of the network entity on at least a portion of the shared radio frequency spectrum band, where the network entity, or the second wireless network, has priority over the one or more APs for communication using the shared radio frequency spectrum band. The operations of 1105 may be performed in accordance with examples as disclosed herein. In some examples, aspects of the operations of 1105 may be performed by a EBCS transmission component 925 as described with reference to FIG. 9.

At 1110, the method may include communicating with at least a first UE via at least the portion of the shared radio frequency spectrum band. The operations of 1110 may be performed in accordance with examples as disclosed herein. In some examples, aspects of the operations of 1110 may be performed by a communications manager component 930 as described with reference to FIG. 9.

Implementation examples are described in the following numbered clauses:

Clause 1: A method for wireless communications at a wireless AP, comprising: monitoring at least a first communications channel of a shared radio frequency spectrum band for one or more enhanced broadcast service (EBCS) uplink frames; receiving an EBCS uplink frame that indicates a presence of a network entity associated with a second wireless network associated with a second RAT different than a first RAT associated with a first wireless network associated with the AP, wherein the network entity of the second wireless network, or the second wireless network, has priority over the AP for communication using the shared radio frequency spectrum band; and adapting communications of the AP via the shared radio frequency spectrum band in accordance with the network entity of the second wireless network, or the second network, having priority over the AP for communication using the shared radio frequency spectrum band.

Clause 2: The method of clause 1, wherein the EBCS uplink frame is transmitted by a transmitter associated with the second wireless network that is acting as an EBCS STA of the first wireless network.

Clause 3: The method of clause 2, wherein the second wireless network is a cellular network or a third generation partnership project (3GPP)-based network, and the first wireless network is a WLAN that operates in accordance with an Institute of Electrical and Electronics Engineers (IEEE) 802.11 protocol, and the transmitter associated with the second wireless network is the network entity or a UE associated with the second wireless network.

Clause 4: The method of any of clauses 1 through 3, wherein the shared radio frequency spectrum band is an upper 6 GHz band that is shared by one or more cellular networks and one or more wireless local area networks.

Clause 5: The method of any of clauses 1 through 4, wherein monitoring at least the first communications channel of the shared radio frequency spectrum band is in accordance with a periodicity for transmission of the EBCS uplink frames that indicate the presence of the network entity of the second wireless network.

Clause 6: The method of any of clauses 1 through 5, further comprising: determining, in accordance with one or more address fields of the EBCS uplink frame, that the EBCS uplink frame is associated with an indication of the presence of the network entity of the second wireless network.

Clause 7: The method of any of clauses 1 through 6, further comprising: decoding a universal resource indicator (URI) from the EBCS uplink frame; and obtaining an indication from a server associated with the URI that the communications of the AP via the shared radio frequency spectrum band are to be adjusted, and one or more corresponding parameters associated with the communications of the AP via the shared radio frequency spectrum band.

Clause 8: The method of any of clauses 1 through 7, further comprising: validating the EBCS uplink frame in accordance with a frame transmit time and a frame count value indicated by the EBCS uplink frame, and wherein the adapting is performed in accordance with the validated EBCS uplink frame.

Clause 9: The method of clause 8, wherein the EBCS uplink frame is validated in accordance with an operator certificate indicated by the EBCS uplink frame.

Clause 10: The method of any of clauses 1 through 9, further comprising: validating, in accordance with a predefined field value of a first field of the EBCS uplink frame, that the EBCS uplink frame is authentic; and parsing, responsive to validation of the EBCS uplink frame, a payload of the EBCS uplink frame, wherein one or more parameters for adapting communications of the AP via the shared radio frequency spectrum band are indicated in the payload.

Clause 11: The method of any of clauses 1 through 10, further comprising: determining that at least one of one or more address fields of the EBCS uplink frame, or the value carried in a universal resource indicator (URI) field of the EBCS uplink frame, correspond to a predefined address field value, and wherein adapting the communications of the AP is performed in accordance with one or more predetermined actions associated with the predefined address field value without forwarding any portion of the EBCS uplink frame to a different entity.

Clause 12: The method of any of clauses 1 through 11, wherein the first communications channel is a preferred scanning channel of the AP within a basic service set bandwidth of the AP.

Clause 13: The method of clause 12, further comprising: monitoring one or more other preferred scanning channels that are outside of the basic service set bandwidth of the AP for the EBCS uplink frame.

Clause 14: The method of any of clauses 1 through 13, wherein the first communications channel is a common channel that is within or outside of a basic service set bandwidth of the AP.

Clause 15: The method of any of clauses 1 through 14, wherein the first communications channel is monitored in association with a procedure to identify an available frequency band for operation of the AP within the first wireless network, and the first communications channel is monitored for a time period in accordance with a periodicity of transmissions of EBCS uplink frames.

Clause 16: The method of any of clauses 1 through 15, further comprising: communicating, prior to receiving the EBCS uplink frame, with one or more stations (STAs) that are associated with the AP using at least the first communications channel, and wherein the monitoring the first communications channel is performed periodically in accordance with a periodicity of transmissions of EBCS uplink frames.

Clause 17: The method of any of clauses 1 through 16, wherein the first communications channel is outside of a primary channel of the AP, and wherein the method further comprises: transmitting an indication to one or more associated stations (STAs) that the AP is unavailable for communications during a monitoring instance of the first communications channel.

Clause 18: The method of any of clauses 1 through 17, wherein the first communications channel is outside of a primary channel of the AP, and wherein the first communications channel is monitored using an auxiliary radio of the AP that is different than a primary radio used for communication with one or more associated stations (STAs) of the AP within the basic service set bandwidth.

Clause 19: The method of any of clauses 1 through 18, further comprising: communicating with one or more associated stations (STAs) via the shared radio frequency spectrum band; requesting one or more associated STAs to monitor for EBCS uplink frames; and monitoring the first communications channel based on receiving an indication of presence of at least one EBCS uplink frame from the one or more associated STAs.

Clause 20: The method of any of clauses 1 through 19, wherein a field within a PPDU containing the EBCS uplink frame is received in a non-high-throughput (non-HT) duplicate physical layer protocol data unit (PPDU).

Clause 21: The method of any of clauses 1 through 20, wherein a field within a physical layer protocol data unit (PPDU) containing the EBCS uplink frame indicates an operational bandwidth of the network entity.

Clause 22: A method for wireless communications at a network entity, comprising: transmitting, to one or more access points (APs) associated with a first wireless network associated with a first RAT different than a second RAT associated with a second wireless network associated with the network entity, on a first communications channel of a shared radio frequency spectrum band, one or more enhanced broadcast service (EBCS) uplink frames that indicate a presence of communications of the network entity on at least a portion of the shared radio frequency spectrum band, wherein the network entity, or the second wireless network, has priority over the one or more APs for communication using the shared radio frequency spectrum band; and communicating with at least a first UE via at least the portion of the shared radio frequency spectrum band.

Clause 23: The method of clause 22, wherein the network entity acts as an EBCS STA of the first wireless network when transmitting the one or more EBCS frames.

Clause 24: The method of clause 23, wherein the second wireless network is a cellular network or a third generation partnership project (3GPP)-based network, and the first wireless network is a WLAN that operates in accordance with an Institute of Electrical and Electronics Engineers (IEEE) 802.11 protocol.

Clause 25: The method of any of clauses 22 through 24, wherein transmitting the one or more EBCS uplink frames is in accordance with a periodicity for transmission of EBCS uplink frames that indicate the presence of the network entity in the shared radio frequency spectrum band.

Clause 26: The method of any of clauses 22 through 25, further comprising: configuring the first UE to transmit one or more EBCS uplink frames in accordance with a presence of one or more defined conditions at the UE.

Clause 27: The method of clause 26, wherein the one or more defined conditions include a packet error rate for uplink communications of the first UE exceeding a threshold value due to interference associated with communications of the first wireless network.

Clause 28: The method of any of clauses 26 through 27, wherein the first UE is configured with one or more security credentials for authentication of the one or more EBCS uplink frames.

Clause 29: The method of any of clauses 22 through 28, wherein the first communications channel is a preferred scanning channel within a basic service set bandwidth of the one or more APs.

Clause 30: The method of any of clauses 22 through 29, wherein the first communications channel is a common channel that is within or outside of a basic service set bandwidth of the one or more APs.

Clause 31: A wireless AP for wireless communications, comprising a processing system that includes processor circuitry and memory circuitry that stores code, the processing system configured to cause the wireless AP to perform a method of any of clauses 1 through 21.

Clause 32: A wireless AP for wireless communications, comprising at least one means for performing a method of any of clauses 1 through 21.

Clause 33: A non-transitory computer-readable medium storing code for wireless communications, the code comprising instructions executable by one or more processors to perform a method of any of clauses 1 through 21.

Clause 34: A network entity for wireless communications, comprising a processing system that includes processor circuitry and memory circuitry that stores code, the processing system configured to cause the network entity to perform a method of any of clauses 22 through 30.

Clause 35: A network entity for wireless communications, comprising at least one means for performing a method of any of clauses 22 through 30.

Clause 36: A non-transitory computer-readable medium storing code for wireless communications, the code comprising instructions executable by one or more processors to perform a method of any of clauses 22 through 30.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method for wireless communications at a wireless access point (AP), comprising:
monitoring at least a first communications channel of a shared radio frequency spectrum band for one or more enhanced broadcast service (EBCS) uplink frames;
receiving an EBCS uplink frame that indicates a presence of a network entity associated with a second wireless network associated with a second radio access technology (RAT) different than a first RAT associated with a first wireless network associated with the AP, wherein the network entity of the second wireless network, or the second wireless network, has priority over the AP for communication using the shared radio frequency spectrum band; and
adapting communications of the AP via the shared radio frequency spectrum band in accordance with the network entity of the second wireless network, or the second wireless network, having priority over the AP for communication using the shared radio frequency spectrum band.

2. The method of claim 1, wherein the EBCS uplink frame is transmitted by a transmitter associated with the second wireless network that is acting as an EBCS station (STA) of the first wireless network.

3. The method of claim 2, wherein:
the second wireless network is a cellular network or a third generation partnership project (3GPP)-based network, and the first wireless network is a wireless local area network (WLAN) that operates in accordance with an Institute of Electrical and Electronics Engineers (IEEE) 802.11 protocol, and
the transmitter associated with the second wireless network is the network entity or a user equipment (UE) associated with the second wireless network.

4. The method of claim 1, wherein the shared radio frequency spectrum band is an upper 6 GHz band that is shared by one or more cellular networks and one or more wireless local area networks.

5. The method of claim 1, wherein monitoring at least the first communications channel of the shared radio frequency spectrum band is in accordance with a periodicity for transmission of the EBCS uplink frames that indicate the presence of the network entity of the second wireless network.

6. The method of claim 1, further comprising:
determining, in accordance with one or more address fields of the EBCS uplink frame, that the EBCS uplink frame is associated with an indication of the presence of the network entity of the second wireless network.

7. The method of claim 1, further comprising:
decoding a universal resource indicator (URI) from the EBCS uplink frame; and
obtaining an indication from a server associated with the URI that the communications of the AP via the shared radio frequency spectrum band are to be adjusted, and one or more corresponding parameters associated with the communications of the AP via the shared radio frequency spectrum band.

8. The method of claim 1, further comprising:
validating the EBCS uplink frame in accordance with a frame transmit time and a frame count value indicated by the EBCS uplink frame, and wherein the adapting is performed in accordance with the validated EBCS uplink frame.

9. The method of claim 1, further comprising:
validating, in accordance with a predefined field value of a first field of the EBCS uplink frame, that the EBCS uplink frame is authentic; and
parsing, responsive to validation of the EBCS uplink frame, a payload of the EBCS uplink frame, wherein one or more parameters for adapting communications of the AP via the shared radio frequency spectrum band are indicated in the payload.

10. The method of claim 1, further comprising:
determining that at least one of one or more address fields of the EBCS uplink frame, or a value carried in a universal resource indicator (URI) field of the EBCS uplink frame, correspond to a predefined address field value, and wherein adapting the communications of the AP is performed in accordance with one or more predetermined actions associated with the predefined address field value without forwarding any portion of the EBCS uplink frame to a different entity.

11. The method of claim 1, wherein the first communications channel is a preferred scanning channel of the AP within a basic service set bandwidth of the AP.

12. The method of claim 1, wherein the first communications channel is a common channel that is within or outside of a basic service set bandwidth of the AP.

13. The method of claim 1, wherein:
the first communications channel is outside of a primary channel of the AP, and wherein the method further comprises:
transmitting an indication to one or more associated stations (STAs) that the AP is unavailable for communications during a monitoring instance of the first communications channel.

14. The method of claim 1, further comprising:
communicating with one or more associated stations (STAs) via the shared radio frequency spectrum band;
requesting one or more associated STAs to monitor for EBCS uplink frames; and
monitoring the first communications channel based on receiving an indication of presence of at least one EBCS uplink frame from the one or more associated STAs.

15. The method of claim 1, wherein a field within a PPDU containing the EBCS uplink frame is received in a non-high-throughput (non-HT) duplicate physical layer protocol data unit (PPDU).

16. The method of claim 1, wherein a field within a physical layer protocol data unit (PPDU) containing the EBCS uplink frame indicates an operational bandwidth of the network entity.

17. A method for wireless communications at a network entity, comprising:
transmitting, to one or more access points (APs) associated with a first wireless network associated with a first radio access technology (RAT) different than a second RAT associated with a second wireless network associated with the network entity, on a first communications channel of a shared radio frequency spectrum band, one or more enhanced broadcast service (EBCS) uplink frames that indicate a presence of communications of the network entity on at least a portion of the shared radio frequency spectrum band, wherein the network entity, or the second wireless network, has priority over the one or more APs for communication using the shared radio frequency spectrum band; and
communicating with at least a first user equipment (UE) via at least the portion of the shared radio frequency spectrum band.

18. The method of claim 17, further comprising:
configuring the first UE to transmit one or more EBCS uplink frames in accordance with a presence of one or more defined conditions at the UE.

19. The method of claim 17, wherein:
the first communications channel is a preferred scanning channel within a basic service set bandwidth of the one or more APs.

20. The method of claim 17, wherein:
the first communications channel is a common channel that is within or outside of a basic service set bandwidth of the one or more APs.

21. A wireless access point (AP), comprising:
a processing system that includes processor circuitry and memory circuitry that stores code, the processing system configured to cause the wireless AP to:
monitor at least a first communications channel of a shared radio frequency spectrum band for one or more enhanced broadcast service (EBCS) uplink frames;
receive an EBCS uplink frame that indicates a presence of a network entity associated with a second wireless network associated with a second radio access technology (RAT) different than a first RAT associated with a first wireless network associated with the AP, wherein the network entity of the second wireless network, or the second wireless network, has priority over the AP priority over the AP for communication using the shared radio frequency spectrum band; and
adapt communications of the AP via the shared radio frequency spectrum band in accordance with the network entity of the second wireless network, or the second wireless network, has priority over the AP for communication using the shared radio frequency spectrum band.

22. The wireless AP of claim 21, wherein the EBCS uplink frame is transmitted by a transmitter associated with the second wireless network that is acting as an EBCS station (STA) of the first wireless network.

23. The wireless AP of claim 21, wherein monitoring at least the first communications channel of the shared radio frequency spectrum band is in accordance with a periodicity for transmission of the EBCS uplink frames that indicate the presence of the network entity of the second wireless network.

24. The wireless AP of claim 21, wherein the processing system is further configured to cause the wireless AP to:
decode a universal resource indicator (URI) from the EBCS uplink frame; and
obtain an indication from a server associated with the URI that the communications of the AP via the shared radio frequency spectrum band are to be adjusted, and one or more corresponding parameters associated with the communications of the AP via the shared radio frequency spectrum band.

25. The wireless AP of claim 21, wherein the processing system is further configured to cause the wireless AP to:
validate, in accordance with a predefined field value of a first field of the EBCS uplink frame, that the EBCS uplink frame is authentic; and
parse, responsive to validation of the EBCS uplink frame, a payload of the EBCS uplink frame, wherein one or more parameters for adapting communications of the AP via the shared radio frequency spectrum band are indicated in the payload.

26. The wireless AP of claim 21, wherein the processing system is further configured to cause the wireless AP to:
communicate with one or more associated stations (STAs) via the shared radio frequency spectrum band;
request one or more associated STAs to monitor for EBCS uplink frames; and
monitor the first communications channel based on receiving an indication of presence of at least one EBCS uplink frame from the one or more associated STAs.

27. A network entity, comprising:
a processing system that includes processor circuitry and memory circuitry that stores code, the processing system configured to cause the network entity to:
transmit, to one or more access points (APs) associated with a first wireless network associated with a first radio access technology (RAT) different than a second RAT associated with a second wireless network associated with the network entity, on a first communications channel of a shared radio frequency spectrum band, one or more enhanced broadcast service (EBCS) uplink frames that indicate a presence of communications of the network entity on at least a portion of the shared radio frequency spectrum band, wherein the network entity, or the second wireless network, has priority over the one or more APs for communication using the shared radio frequency spectrum band; and
communicate with at least a first user equipment (UE) via at least the portion of the shared radio frequency spectrum band.

28. The network entity of claim 27, wherein transmitting the one or more EBCS uplink frames is in accordance with a periodicity for transmission of EBCS uplink frames that indicate the presence of the network entity in the shared radio frequency spectrum band.

29. The network entity of claim 27, wherein the processing system is further configured to cause the network entity to:
configure the first UE to transmit one or more EBCS uplink frames in accordance with a presence of one or more defined conditions at the UE.

30. The network entity of claim 29, wherein the first UE is configured with one or more security credentials for authentication of the one or more EBCS uplink frames.
